(19) United States
(12) Patent Application Publication
(10) Pub. No.: US 2013/0248454 A1
(43) Pub. Date: Sep. 26, 2013

(54) PRODUCED WATER TREATMENT IN OIL RECOVERY

(71) Applicant: E I DU PONT DE NEMOURS AND COMPANY, Wilmington, DE (US)

(72) Inventors: SIMON FRISK, Newark, DE (US); Hyun Sung Lim, Midlothian, VA (US); Lisa C Bates, Chester, VA (US); Peter Andrin, Bath (CA); Basil El-Borno, Calgary Alberta (CA)

(73) Assignee: E I DU PONT DE NEMOURS AND COMPANY, Wilmington, DE (US)

(21) Appl. No.: 13/848,783

(22) Filed: Mar. 22, 2013

Related U.S. Application Data
(60) Provisional application No. 61/614,109, filed on Mar. 22, 2012.

(51) Int. Cl. C02F 1/52

(52) U.S. Cl. CPC C02F 1/52
USPC 210/702; 210/170.07

(57) ABSTRACT

An oil recovery process that utilizes one or more filtration media having an efficiency of 30% or greater for particles of 1 micrometer size or greater and a flow rate of 2 milliliters per minute per centimeter squared of media per unit pressure of the liquid (ml/min/cm2/kPa) to remove silica and/or oil and/or dissolved organics and/or dissolved solids from produced water which includes separating oil from the produced water and precipitating silica into particles and wherein the produced water having the precipitated silica is directed to a filtration medium which operates in a direct flow filtration mode and removes the precipitated silica from the produced water to form a permeate stream.

### BACKGROUND OF THE INVENTION

1. Field of the Invention

The present invention relates to a process for recovering heavy oil and extra-heavy oil, more particularly, to an oil recovery process that utilizes a filtration process to remove silica and residual oil from produced water upstream of water treatment and steam generation processes.

2. Description of the Related Art

Conventional primary oil recovery involves drilling a well and pumping a mixture of oil and water and sometimes gas from the well. Oil is separated from the water and the gas. The water recovered, known as produced water, can be recovered for other uses and is often (and is usually) injected into a sub-surface formation. Conventional recovery works well for low and medium viscosity oils and for the initial oil that is first to be produced from the reservoir and easiest to remove from the reservoir.

For low and medium viscosity oils that are recovered later from the reservoir or are more difficult to extract from the reservoir, many types of enhanced oil recovery processes are used. These processes are called secondary recovery processes, tertiary recovery processes, and more generally enhanced oil recovery (EOR) processes. A common enhanced recovery process uses water, sometimes with chemicals, to extract oil from the reservoir that could not be recovered during the primary recovery step. Often, up to 20 times the volume of water can be used to recover a single volume unit of oil and the recovery process is often called waterflooding. When chemicals are used the process can be called chemical flooding. Chemical flooding includes alkaline, surfactant, polymer and alkaline-surfactant-polymer flooding. The water used in the process is raised to the surface with the oil and sometimes with gas. Oil is separated from the water and the gas. The produced water is recovered, treated and then recycled back into the process to continue the waterflood.

The primary recovery, waterflooding, and chemical flooding processes operate at ambient temperature. Oil/water separation technology and water treatment technologies that have been developed for ambient temperature processes work well in these recovery processes. However, conventional primary oil recovery processes and enhanced oil recovery processes that operate at ambient temperature do not work well for higher viscosity, heavy oil and extra-heavy oil.

Recovery processes that employ thermal methods are used to improve the recovery of heavy oils and extra-heavy oils from sub-surface reservoirs. Thermal methods use steam injection and in-situ combustion. The injection of steam into heavy oil bearing formations is a widely practiced EOR method. For continuous steam recovery processes several tons of steam are required for each ton of oil recovered. In the Steam Assisted Gravity Drainage process (SAGD), the steam is injected at a temperature above 200 deg C. and condenses inside the reservoir, raising the temperature of the overall reservoir. The higher temperature lowers the viscosity of the oil in the reservoir and allows the oil and the condensed steam to flow downward by gravity to a collection well. (Steam condenses and mixes with the oil, to form an oil/water mixture.) The mixture of oil and water and gas is raised to the surface, either through natural pressure or by artificial lift. Since the recovery process is done at elevated temperatures, much tighter emulsions are formed by the produced liquids and the water contains much greater levels of dissolved organics, solids and silica. In addition, in many jurisdictions where SAGD is practiced, regulations are in effect that impose a requirement for producers to recover and re-use up to at least 90% of the water when non-saline make-up water is used.

Above ground in a centralized SAGD facility, the oil is separated from the water by using de-emulsification chemistries and several water-oil separation and de-oiling steps. These de-oiling steps include a skim tank, gas flotation, and oil removal filters. After the water is de-oiled, the water is fed to a process to remove dissolved species including silica. The initial oil/water separation step is done at temperatures close to the temperature in the reservoir. After the primary oil/water separation step, the temperature of the recovered water stream is reduced below the atmospheric boiling point of water in order to reduce the requirements for pressure vessels needed for subsequent de-oiling and dissolved species removal steps. Significant energy savings are incurred by operating the de-oiling and dissolved species removal steps close to the atmospheric boiling point of water. The heat loss from the process would be significant if the water treatment process temperature were to be further reduced to ambient temperatures most commonly used for conventional water treatment processes. The higher water treatment temperature imposes special requirements that are not well-suited for conventional water treatment technologies.

Two processes in use today for removing dissolved species, including reactive and colloidal silica are referred to as (a) warm lime softening, (mechanical separation of particles and weak acid cation exchange) and (b) evaporative (mechanical vapor recompression) processes. Both processes remove sufficient contaminants in the water to allow this water to be fed to a steam generator to make steam. However, both processes do not function as well as is needed to reduce the tendency for fouling of the process. Silica in the water typically creates frequent fouling in the steam generators downstream of the warm lime softener or inside the evaporator and the steam generators when that process is used. Fouling, when improperly managed, can cause catastrophic failure in steam generators and evaporators. Fouling, even when properly managed, can cause increased scheduled or unscheduled downtime, reduce energy efficiency of the SAGD process, reduce the steam generation capacity for the process, and create lower temperatures in the oil producing reservoir which hamper oil recovery.

Recovery of at least 90% of the produced water that has been injected into the well as steam is desirable. In this regard, membranes have been used to remove the silica with which the water becomes contaminated. For example U.S. Pat. No. 8,047,287 employs a ceramic membrane which operates in a cross-flow mode.

Ceramic and other membranes are typically operated in the tangential flow filtration mode (aka cross-flow filtration mode) in this end-use. Cross-flow filtration is a continuous process in which the feed stream flows parallel (tangential) to the membrane filtration surface and generates two outgoing streams. In the cross-flow filtration process, only a small fraction of feed (typically 1-10%) called permeate or filtrate, separates out as purified liquid passing through the membrane. The remaining fraction of feed, called retentate or concentrate contains particles rejected by the membrane. There is a need for a process that allows more than a small fraction of the feed to be purified, and preferably all of the feed to be purified.

### SUMMARY OF THE INVENTION

The present invention relates to an oil recovery process that utilizes one or more filtration media to remove silica and/or oil and/or dissolved organics and/or dissolved solids from produced water. In one embodiment, the process includes separating oil from the produced water and precipitating silica into particles. The produced water having the precipitated silica is directed to a filtration medium which operates in a direct flow filtration mode (also known as dead-end filtration mode) and removes the precipitated silica from the produced water to form a permeate stream. In some cases residual oil is present and may be removed by the filtration process.

The filtration medium may have an efficiency of 30% or greater for particles of 1 micrometer size or greater and a flow rate of 2 milliliters per minute per centimeter squared of media per unit pressure of the liquid (ml/min/cm²/kPa).

In one embodiment of the process, filtering of the produced water with the medium produces a filter cake upstream of, and in contact with, the medium and concentrated with the precipitated silica and wherein the filter cake is allowed to build to a pre-determined level.

The present application also discloses a method of removing oil from an oil well and treating produced water including recovering an oil/water mixture from the well and separating oil from the oil/water mixture to produce an oil product and purified produced water as a permeate stream. One embodiment of the method also includes mixing a crystallizing reagent with the produced water and precipitating solids from the produced water and forming particles in the produced water. A caustic compound may also be mixed with the produced water to adjust the pH to approximately 9.5 to approximately 11.2. After mixing the crystallizing reagent with the produced water, the produced water is directed to a filtration medium operated in direct flow mode so that essentially 100% of the water recovered is essentially free of particles in the size range of 5 micrometers or higher or even 2 micrometers or higher, or even 1 micrometer or higher, or even 0.5 micrometer or higher.

In one embodiment of the invention, the de-oiled water stream may be split into two streams. One of the streams is further purified by the process of the invention and the resulting permeate stream is mixed with a non-purified stream to form a stream that is free enough of impurities to be used in the remaining steps of the oil recovery process.

The other objects and advantages of the present invention will become apparent and obvious from a study of the following description and the accompanying drawings which are merely illustrative of such invention.

The invention is also directed to a system for removing oil from a subterranean well. The system comprises;
i) a means for separating oil from an oil/water mixture to produce a stream of water having dissolved and particulate silica
ii) a means for precipitating the silica
iii) a filtration medium through which essentially all of the water passes

The medium has an efficiency of 30% or greater for particles of 1 micrometer size or greater at a flow rate of 2 milliliters per minute per centimeter square of media per unit pressure of the liquid (ml/min/cm²/kPa). Filtering the produced water with the medium produces a filter cake upstream of, and in contact with, the medium and concentrated with the precipitated silica and wherein the filter cake is allowed to build to a pre-determined level until being replaced by a cake-free membrane.

### DETAILED DESCRIPTION OF THE INVENTION

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

### DEFINITION OF TERMS

The term “dissolved silica” as used herein, describes both reactive and colloidal silica. Silica is generally found in water in three different forms: reactive, colloidal and suspended particles (e.g., sand), with the reactive being that portion of the total dissolved silica that is readily reacted in the standard molybdate colorimetric test, and the colloidal being that which is not.

The term “polymer” as used herein, generally includes but is not limited to, homopolymers, copolymers (such as for example, block, graft, random and alternating copolymers), terpolymers, etc., and blends and modifications thereof. Furthermore, unless otherwise specifically limited, the term “polymer” shall include all possible geometrical configurations of the material. These configurations include, but are not limited to isotactic, syndiotactic, and random symmetries.

The term “polyolefin” as used herein, is intended to mean any of a series of largely saturated polymeric hydrocarbons composed only of carbon and hydrogen. Typical polyolefins include, but are not limited to, polyethylene, polypropylene, polymethylpentene, and various combinations of the monomers ethylene, propylene, and methylpentene.

The term “polyethylene” as used herein is intended to encompass not only homopolymers of ethylene, but also copolymers wherein at least 85% of the recurring units are ethylene units such as copolymers of ethylene and alpha-olefins. Preferred polyethylenes include low-density polyethylene, linear low-density polyethylene, and linear high-density polyethylene. A preferred linear high-density polyethylene has an upper limit melting range of about 130° C. to 140° C., a density in the range of about 0.941 to 0.980 gram per cubic centimeter, and a melt index (as defined by ASTM D-1238-57T Condition E) of between 0.1 and 100, and preferably less than 4.

The term “polypropylene” as used herein is intended to embrace not only homopolymers of propylene but also copolymers where at least 85% of the recurring units are propylene units. Preferred polypropylene polymers include isotactic polypropylene and syndiotactic polypropylene.

The term “nonwoven” as used herein means a sheet structure of individual fibers or threads that are positioned in a random manner to form a planar material without an identifiable pattern, as in a knitted fabric.

The term “plexifilament” as used herein means a three-dimensional integral network or web of a multitude of thin, ribbon-like, film-fibril elements of random length and with a mean film thickness of less than about 4 micrometers and a median fibril width of less than about 25 micrometers. The average film-fibril cross sectional area if mathematically converted to a circular area would yield an effective diameter between about 1 micrometer and 25 micrometers. In plexifilamentary structures, the film-fibril elements intermittently unite and separate at irregular intervals in various places throughout the length, width and thickness of the structure to form a continuous three-dimensional network.

The process of the invention calls for “essentially all” or “essentially 100%” of the water impinging on the filter medium to pass through it. By “essentially all” is meant that the only produced water that does not pass through the medium is loss by leakage or waste. There is no separate retentate stream produced by the process.

### Embodiments of the Invention

The present invention entails a process for cleaning produced water, for use in heavy oil and extra-heavy oil recovery, comprising thermal in-situ recovery processes. The treated produced water may be used for steam generation. In some applications, oil recovery is accomplished by injecting steam into heavy-oil bearing underground formations. In the Steam Assisted Gravity Drainage (SAGD) and Cyclic Steam Stimulation (CSS) processes, the steam heats the oil in the reservoir, which reduces the viscosity of the oil and allows the oil to flow and be collected. Steam condenses and mixes with the oil, to form an oil/water mixture. The mixture of oil and water is pumped to the surface. Oil is separated from the water by conventional processes employed in conventional oil recovery operations to form produced water. The produced water is re-used to generate steam to feed back into the oil-bearing formation.

Produced water includes dissolved organic ions, dissolved organic acids and other dissolved organic compounds, suspended inorganic and organic solids, and dissolved gases. Typically, the total suspended solids in the produced water after separation from the oil is less than about 1000 ppm. In addition to suspended solids, produced water from heavy oil recovery processes includes dissolved organic and inorganic solids in varying portions. Dissolved and suspended solids, in particular silica-based compounds, in the produced water have the potential to foul purification and steam generation equipment by scaling. Additional treatment is therefore desirable after oil/water separation to remove suspended silica-based compounds from the produced water. Hereinafter, the term “silica” will be used to refer generally to silica-based compounds.

In order to prevent silica scaling and/or fouling of purification and steam generation equipment, the present invention provides that produced water be treated by using a filtration process to substantially remove silica from the produced water. The produced water, having silica removed, may be further purified by any of a variety of purification processes including reverse osmosis, evaporation, and ion exchange treatment before being directed to steam generation equipment. Steam generation equipment may include at least boilers and once-through steam generators.

The present invention is directed to a process that utilizes filtration media in oil recovery processes. The invention is also directed to a system for recovering oil that recovers and re-uses greater than 90% of the water that is used in the oil extraction part of the process.

In one embodiment of the invention, silica contamination can be removed from a waste stream with one or more filtration media. In an oil recovery process, for example, silica may be effectively removed with filtration media. In order to prevent silica scaling of the purification and steam generation equipment, the processes disclosed herein provide that produced water is treated by using a filtration process to substantially remove silica from produced water or from other streams, such as a concentrate brine stream, that may be produced in the process of treating a produced water stream. In the case of produced water, after silica is removed, the produced water can be further purified by any of a variety of purification processes including reverse osmosis, evaporation, ion exchange of treatment, after which the treated stream can be directed to steam generation equipment. In one embodiment of the invention, following the oil/water separation, the fluid stream is split into two streams. One stream is treated as described above, to produce a permeate stream in which, for example, the silica has been removed. The second stream may or may not undergo any further treatment. The two streams are then combined to form a stream that is free enough of impurities to be used in the remaining steps in the oil recovery process.

The general process of the present invention comprises an oil/water mixture that has been recovered from a well and is directed to an oil/water separation process which effectively separates the oil from the water. This is commonly referred to as primary separation and can be carried out by various conventional means or processes such as gravity or centrifugal separation. Separated water may be subjected, in some cases, to a de-oiling process where additional oil is removed from the water. Resulting water from the oil/water separation process is referred to as produced water. Produced water may be at temperatures of greater than 90° C. or even greater than 100° C. Produced water contains residual suspended silica solids, emulsified oil, dissolved organic materials, and dissolved solids. Produced water is directed to a filtration medium for silica removal. It should be pointed out that silica, residual oil and dissolved organics can be removed simultaneously, or in stages with multiple filtration media. The filtration medium generates a permeate stream which may be further directed to an optional downstream purification process, such as an evaporation process, or other purification processes, such as ion exchange systems.

During the filtration process a cake builds up on the filtration medium and upstream and in contact with it. The cake is essentially solid and porous and allows produced water to pass through it while also acting to filter out suspended particles and/or other contaminants. When the cake size reaches a pre-determined level the filter medium plus cake is removed from the process stream and replaced by a fresh filter medium with no cake, or only a partial cake, formed thereon. The process of building up a cake is repeated. The pre-determined level can typically be determined as the point at which the increasing pressure required to maintain acceptable flow through the cake plus medium combination is too high for the operation, or when the flow rate across the cake plus medium decreases to an unacceptable level for a constant fluid pressure.

The cake is dewatered and then separated from the filtration medium away from the process stream and collected as solid waste. A downstream purification process may be used to further purify the permeate and produce a purified water stream. The purified water is directed to a steam generation process. The generated steam can be injected into the oil-bearing formation to form the oil/water mixture that is collected and pumped to the surface where oil is separated therefrom.

As a means for precipitating the silica, the produced water may also be dosed, (prior to contact with the filter medium) with a crystal-forming compound such as magnesium oxide. Various crystal-forming materials can be added. In some cases magnesium may be added in the form of magnesium oxide or magnesium chloride. In any event, the magnesium compound forms magnesium hydroxide crystals that function to sorb silica in the produced water, resulting in the conversion of silica from soluble to insoluble form. It should be noted that there is typically an insufficient concentration of magnesium found in produced water to yield a substantial amount of magnesium hydroxide crystals. Thus, in the case of using magnesium for crystal formation, the process generally requires the addition of magnesium to the produced water. Other reagents or compounds may also be mixed with the produced water to remove silica through precipitation or adsorption. For example, ferric chloride, aluminum oxide, aluminum sulfate, calcium oxide or alum may be mixed with the produced water. In some cases the dissolved silica in the produced water can be removed from solution by mixing compounds with the produced water where the compounds have surface-active properties. The surface-active properties may draw silica out of solution. Examples of such compounds are oxides of aluminum, silica and titanium.

The pH of the produced water may be maintained in the range of 9.5 to 11.2, and preferably between 10.0 and 10.8 for optimum precipitation of silica. Some caustic material such as sodium hydroxide or sodium carbonate may be added to trim the pH to a proper value. The duration of the crystallization process only needs to be for a time period sufficient to create crystals large enough to be captured by the filtration medium and prevent scaling/fouling of the downstream purification and steam generation processes. Duration does not have to be so long as to promote the growth of large silica crystals.

The crystallization process generates a suspension of crystals in the produced water. In the case of magnesium hydroxide crystals, these crystals adsorb and pull silica out of solution, effectively precipitating the silica. The produced water with the precipitated silica crystals, along with any insoluble silica that was present in the raw produced water, is directed to the filtration medium. The filtration medium develops a cake thereon having the insoluble silica therein. Permeate produced by the filtration medium is directed downstream for further purification or to a steam generation process. Typically, essentially 100% of the water in the feed stream will pass through the filtration medium as permeate, with only small amounts left in the filter cake and incidental amounts failing to do because of spillage etc. It is believed that the permeate downstream from the filtration medium will typically have a silica concentration in the range of 0-50 ppm and a pH of 9.5 to 11.2.

The present invention utilizes a filtration medium to substantially remove silica from produced water as part of a water cleaning and purification process that produces steam for injection into oil-bearing formations. In the embodiments described, a filtration medium is utilized upstream of other water purification processes. A filtration medium process may also be utilized elsewhere in such overall processes for removal of oil and other undesirable contaminants from the water.

Filtration media, useful in the processes disclosed herein, can be of various types. Media can be a nonwoven or a woven structure. The media can be a combination of multiple layers. The filtration media may be designed to withstand relatively high temperatures as it is not uncommon for the produced water being filtered by the filtration media to have a temperature of approximately 90° C. or higher.

In the preferred embodiment, the media of the present invention comprises a nonwoven sheet, or a multilayered structured composed of at least one nonwoven sheet. The nonwoven sheet may comprise polymeric and/or non-polymeric fibers. The nonwoven sheet may also comprise inorganic fibers. The polymeric fibers are made from polymers selected from the group consisting of polyolefins, polyesters, polyamides, polyaramids, polysulfones and combinations thereof. The polymeric fibers may have an average diameter above or below 1 micrometer, and be essentially round, or have non-circular or more complex cross-sectional shapes. The nonwoven sheet has a water flow rate per unit area of the sheet, per unit pressure drop across the sheet of at least 3, 5, 10, 15 or even 20 ml/min/cm²/KPa, a filtration efficiency rating of at least 30, 40, 50, 60, 70 or even 80% at a 1.0 micrometer particle size, a life of a least 150 minutes.

In one embodiment, the nonwoven sheet is composed of high-density polyethylene fibers made according to the flash-spinning process disclosed in U.S. Pat. No. 7,744,989 to Marin et al., which is hereby incorporated by reference, with additional thermal stretching prior to sheet bonding. Preferably, the thermal stretching comprises uniaxially stretching the unbonded web in the machine direction between heated draw rolls at a temperature between about 124° C. and about 154° C., positioned at relatively short distances less than 32 cm apart, preferably between about 5 cm and about 30 cm apart, and stretched between about 3% and 25% to form the stretched web. Stretching at draw roll distances more than 32 cm apart may cause significant necking of the web which would be undesirable. Typical polymers used in the flash-spinning process are polyolefins, such as polyethylene and polypropylene. It is also contemplated that copolymers comprised primarily of ethylene and propylene monomer units, and blends of olefin polymers and copolymers could be flash-spun. For example, a liquid filtration medium can be produced by a process comprising flash spinning a solution of 12% to 24% by weight polyethylene in a spin agent consisting of a mixture of normal pentane and cyclopentane at a spinning temperature from about 205° C. to 220° C. to form plexifilamentary fiber strands and collecting the plexifilamentary fiber strands into an unbonded web, uniaxially stretching the unbonded web in the machine direction between heated draw rolls at a temperature between about 124° C. and about 154° C., positioned between about 5 cm and about 30 cm apart and stretched between about 3% and 25% to form the stretched web, and bonding the stretched web between heated bonding rolls at a temperature between about 124° C. and about 154° C. to form a nonwoven sheet. The nonwoven sheet has a water flow rate of at least 5, preferably 20, ml/min/cm²/kPa, a filtration efficiency rating of at least 60% at a 1.0 micrometer particle size, and a life expectancy of at least 150 minutes.

In one embodiment, the polymeric fibers are made from polyether sulfone using the electroblowing process for making the nanofiber layer(s) of the filtration medium disclosed in International Publication Number WO2003/080905 (U.S. Ser. No. 10/822,325), which is hereby incorporated by reference. The electroblowing method comprises feeding a solution of a polymer in a solvent from a mixing chamber through a spinning beam, to a spinning nozzle to which a high voltage is applied, while compressed gas is directed toward the polymer solution in a blowing gas stream as it exits the nozzle. Nanofibers are formed and collected as a web on a grounded collector under vacuum created by vacuum chamber and blower. For example, the resulting nonwoven sheet has a water flow rate of at least 30 ml/min/cm²/kPa, a filtration efficiency rating of at least 30% at a 1.0 micrometer particle size, and a life expectancy of at least 250 minutes.

The media of the invention may further comprise a scrim layer in which the scrim is located adjacent to the nonwoven sheet. A “scrim”, as used here, is a support layer and can be any planar structure which optionally can be bonded, adhered or laminated to the nonwoven sheet. Advantageously, the scrim layers useful in the present invention are spunbond nonwoven layers, but can be made from carded webs of nonwoven fibers and the like.

Filtration media may also have an asymmetrical structure composed of at least two, mostly three, different porosity levels. An example of such structure may be one in which the top layer provides the main filtration performance, the intermediate layer provides a pre-filtration layer to extend the life of the top layer and bottom layer provides the support to ensure the mechanical resistance of the filter.

In one embodiment, the filtration media is used in a pressure filter system. The filter assembly typically comprises a vertical or horizontal stack of filter plates including a lower filter plate and an upper filter plate, one of which is mounted to a rigid structure or frame, called the filter press, and a variable number of intermediate filter plates, movably mounted to the fixed plate or filter press, between the upper and lower plates. A layer of filter media, usually provided in long sheet-like rolls, is placed between each pair of filter plates. Each pair of filter plates, together with the filter media between the members of a pair, forms dirty and clean compartments. The dirty compartment receives unfiltered, contaminated liquid under pressure which is thus forced through the filter media, thereby depositing the filter cake solids (contaminants with or without a filter aid) on the filter media. The resultant clean, filtered liquid enters the clean compartment of the adjacent plate and exits the filter assembly.

During the filtration process a cake builds up on the filtration medium and upstream and in contact with it. The cake is essentially solid and porous, and allows produce water to pass through it while also acting to filter out suspended particles. When the cake size reaches a pre-determined level the filter medium plus cake is removed from the process stream and replaced by a fresh filter medium with no cake, or only a partial cake, formed thereon. The replacement of the filter medium can be done manually or automatically, such as when using an automatic pressure filter. The cake is separated from the medium and collected as waste. The process of building up a cake is repeated. Normally the pre-determined level will be determined as the point at which the pressure required to maintain acceptable flow through the cake plus medium combination is too high for the operation. Alternatively, the pre-determined level could be the point at which the flow is reduced below an acceptable level, at a specific fluid pressure.

Certain applications may require the filter media discussed above to be supplemented with the addition of filter aids in the form of diatomaceous earth and/or Fuller's earth, or other similar products. These filter aids contribute in the formation a filter cake on the filter media, which may facilitate the separation of the particles and other contaminants from the liquid to further purify the working liquid in the filter assembly.

The use of filter aids is discussed herein since, when the filter aids are used, they combine with impurities from the dirty liquid to form a filter cake deposited upon the filter media. As noted above, filter assemblies of the type contemplated by the present invention are adapted for retrieval of the spent filter media and it is desirable to first separate the filter solids from the filter media. Otherwise, the use of filter aids and the manner in which they are selected and introduced into the filter system are not within the scope of the present invention and accordingly are not discussed in greater detail herein.

Filter assemblies including filter stacks with multiple filter chambers or compartments and employing filter media for separating solid contaminants from a dirty liquid have been disclosed for example in U.S. Pat. No. 4,274,961 issued Jun. 23, 1981 to Hirs; U.S. Pat. No. 4,289,615 issued Sep. 15, 1981 to Schneider, et al. and U.S. Pat. No. 4,362,617 issued Dec. 7, 1982 to Klepper.

An advantage of the method of the present invention is the easy removal of particulates from a slurry of particulates and a liquid. The system of the invention will typically remove more than 90% of the silica in produced water.

The present invention may be carried out in ways other than those specifically set forth herein without departing from essential characteristics of the invention. The present embodiments are to be considered in all respects as illustrative and not restrictive, and all changes coming within the meaning and equivalency range of the appended claims are intended to be embraced therein.

### EXAMPLES

In the non-limiting Examples that follow, the following test methods were employed to determine various reported characteristics and properties. ASTM refers to the American Society of Testing Materials.

Basis Weight was determined by ASTM D-3776, which is hereby incorporated by reference and report in g/m².

Water Flow Rate was determined as follows. A closed loop filtration system consisting of a 60 liter high density polyethylene (HDPE) storage tank, Levitronix LLC (Waltham, Mass.) BPS-4 magnetically coupled centrifugal high purity pump system, Malema Engineering Corp. (Boca Raton, Fla.) M-2100-T3104-52-U-005/USC-731 ultrasonic flow sensor/meter, a Millipore (Billerica, Mass.) 90 mm diameter stainless steel flat sheet filter housing (51.8 cm² filter area), pressure sensors located immediately before and after the filter housing and a Process Technology (Mentor, Ohio) TherMax2 IS1.1-2.75-6.25 heat exchanger located in a separate side closed loop.

A 0.1 micrometer filtered deionized (DI) water was added to a sixty liter HDPE storage tank. The Levitronix pump system was used to automatically, based on the feedback signal from the flowmeter, adjust the pump rpm to provide the desired water flow rate to the filter housing. The heat exchanger was utilized to maintain the temperature of the water to approximately 20° C. Prior to water permeability testing, the cleanliness of the filtration system was verified by placing a 0.2 micrometer polycarbonate track etch membrane in the filter housing and setting the Levitronix pump system to a fixed water flow rate of 1000 ml/min. The system was declared to be clean if the delta pressure increased by <0.7 KPa over a 10 minute period.

The track etch membrane was removed from the filter housing and replaced with the media for water permeability testing. The media was then wetted with isopropyl alcohol and subsequently flushed with 1-2 liters of 0.1 micrometer filtered DI water. The water permeability was tested by using the Levitronix pump system to increase the water flow rate at 60 ml/min intervals from 0 to 3000 ml/min. The upstream pressure, downstream pressure and exact water flow rate were recorded for each interval. The slope of the pressure vs. flow curve was calculated in ml/min/cm²/KPa, with higher slopes indicating higher water permeability.

Filtration Efficiency measurements were made by test protocol developed by ASTM F795. A 50 ppm ISO test dust solution was prepared by adding 2.9 g of Powder Technology Inc. (Burnsville, Minn.) ISO 12103-1, A3 medium test dust to 57997.1 g 0.1 micrometer filtered DI water in a sixty liter HDPE storage tank. Uniform particle distribution was achieved by mixing the solution for 30 minutes prior to filtration and maintained throughout the filtration by using an IKA Works, Inc. (Wilmington, N.C.) RW 16 Basic mechanical stirrer set at speed nine with a three inch diameter three-blade propeller and also re-circulated with a Levitronix LLC (Waltham, Mass.) BPS-4 magnetically coupled centrifugal high purity pump system. Temperature was controlled to approximately 20° C. using a Process Technology (Mentor, Ohio) TherMax2 IS1.1-2.75-6.25 heat exchanger located in a side closed loop.

Prior to filtration, a 130 ml sample was collected from the tank for subsequent unfiltered particle count analysis. Filtration media was placed in a Millipore (Billerica, Mass.) 90 mm diameter stainless steel flat sheet filter housing (51.8 cm² filter area), wetted with isopropyl alcohol and subsequently flushed with 1-2 liters of 0.1 micrometer filtered DI water prior to starting filtration.

Filtration was done at a flow rate of 200 ml/min utilizing a single pass filtration system with a Malema Engineering Corp. (Boca Raton, Fla.) M-2100-T3104-52-U-005/USC-731 ultrasonic flow sensor/meter and pressure sensors located immediately before and after the filter housing. The Levitronix pump system was used to automatically (based on the feedback signal from the flowmeter) adjust the pump rpm to provide constant flow rate to the filter housing. The heat exchanger was utilized to control the temperature of the liquid to approximately 20° C. in order to remove this variable from the comparative analysis as well as reduce evaporation of water from the solution that could skew the results due to concentration change.

The time, upstream pressure and downstream pressure were recorded and the filter life was recorded as the time required to reach a delta pressure of 69 kPa.

Filtered samples were collected at the following intervals: 2, 5, 10, 20, 30, 60 and 90 minutes for subsequent particle count analysis. The unfiltered and filtered samples were measured for particle counts using Particle Measuring Systems Inc. (Boulder, Colo.) Liquilaz SO2 and Liquilaz SO5 liquid optical particle counters. In order to measure the particle counts, the liquids were diluted with 0.1 micrometer filtered DI water to a final unfiltered concentration at the Liquilaz SO5 particle counting sensor of approximately 4000 particle counts/ml. The offline dilution was done by weighing (0.01 g accuracy) 880 g 0.1 micrometer filtered DI water and 120 g 50 ppm ISO test dust into a 1 L bottle and mixing with a stir bar for 15 minutes. The secondary dilution was done online by injecting a ratio of 5 ml of the diluted ISO test dust into 195 ml 0.1 μm filtered DI water, mixing with a inline static mixer and immediately measuring the particle counts. Filtration efficiency was calculated at a given particle size from the ratio of the particle concentration passed by the medium to the particle concentration that impinged on the medium within a particle “bin” size using the following formula.

Efficiency_{(α size)}(%)=(Nᵤₚₛₜᵣₑₐₘ−N_{downstream})*100/Nᵤₚₛₜᵣₑₐₘ

Life Expectancy (synonymous with “capacity”) is the time required to reach a terminal pressure of 10 psig (69 kPa) across the filter media during the filtration test described above.

Mean Flow Pore Size was measured according to ASTM Designation E 1294-89, “Standard Test Method for Pore Size Characteristics of Membrane Filters Using Automated Liquid Porosimeter.” with a capillary flow porosimeter (model number CFP-34RTF8A-3-6-L4, Porous Materials, Inc. (PMI), Ithaca, N.Y.). Individual samples of different sizes (8, 20 or 30 mm diameter) were wetted with a low surface tension fluid (1, 1, 2, 3, 3, 3-hexafluoropropene, or “Galwick,” having a surface tension of 16 dyne/cm) and placed in a holder, and a differential pressure of air is applied and the fluid removed from the samples. The differential pressure at which wet flow is equal to one-half the dry flow (flow without wetting solvent) is used to calculate the mean flow pore size using supplied software.

Nominal Rating 90% Efficiency is a measure of the ability of the media to remove a nominal percentage (i.e. 90%) by weight of solid particles of a stated micrometer size and above. The micrometer ratings were determined at 90% efficiency at a given particle size.

### Examples 1 and 2

Examples 1 and 2 were made from flash spinning technology as disclosed in U.S. Pat. No. 7,744,989, incorporated herein by reference, with additional thermal stretching prior to sheet bonding. Unbonded nonwoven sheets were flash spun from a 20 weight percent concentration of high density polyethylene having a melt index of 0.7 g/10 min (measured according to ASTM D-1238 at 190° C. and 2.16 kg load) in a spin agent of 60 weight percent normal pentane and 40 weight percent cyclopentane. The unbonded nonwoven sheets were stretched and whole surface bonded. The sheets were run between pre-heated rolls at 146° C., two pairs of bond rolls at 146° C., one roll for each side of the sheet, and backup rolls at 146° C. made by formulated rubber that meets Shore A durometer of 85-90, and two chill rolls. Examples 1 and 2 were stretched 6% and 18% between two pre-heated rolls with 10 cm span length at a rate of 30.5 and 76.2 m/min, respectively. The delamination strength of Examples 1 and 2 was 0.73 N/cm and 0.78 N/cm, respectively. The sheets' physical and filtration properties are given in the Table.

### Example 3

Example 3 was prepared similarly to Examples 1 and 2, except without the sheet stretching. The unbonded nonwoven sheet was whole surface bonded as disclosed in U.S. Pat. No. 7,744,989. Each side of the sheet was run over a smooth steam roll at 359 kPa steam pressure and at a speed of 91 m/min. The delamination strength of the sheet was 1.77 N/cm. The sheet's physical and filtration properties are given in the Table.

### Examples 4-6

Examples 4-6 were PolyPro XL disposal filters PPG-250, 500 and 100 which are rated by retention at 2.5, 5 and 10 micrometers, respectively (available from Cuno of Meriden, Conn.). They are composed of polypropylene calendered meltblown filtration media rated for 2.5, 5 and 10 micrometers, respectively. The sheets' physical and filtration properties are given in the Table.

### Example 7

Example 7 is a polyether sulfone nanofiber based nonwoven sheet made by an electroblowing process as described in WO 03/080905. PES (available through HaEuntech Co, Ltd. Anyang SI, Korea, a product of BASF) was spun using a 25 weight percent solution in a 20/80 solvent of N, N Dimethylacetamide (DMAc) (available from Samchun Pure Chemical Ind. Co Ltd, Gyeonggi-do, Korea), and N, N Dimethyl Formamide (DMF) (available through HaEuntech Co, Ltd. Anyang SI, Korea, a product of Samsung Fine Chemical Co). The polymer and the solvent were fed into a solution mix tank, and then the resulting polymer solution transferred to a reservoir. The solution was then fed to the electro-blowing spin pack through a metering pump. The spin pack has a series of spinning nozzles and gas injection nozzles. The spinneret is electrically insulated and a high voltage is applied. Compressed air at a temperature between 24° C. and 80° C. was injected through the gas injection nozzles. The fibers exited the spinning nozzles into air at atmospheric pressure, a relative humidity between 50 and 72% and a temperature between 13° C. and 24° C. The fibers were laid down on a moving porous belt. A vacuum chamber beneath the porous belt assisted in the laydown of the fibers. The number average fiber diameter for the sample, as measured by technique described earlier, was about 800 nm. The physical properties and filtration performance of the produced sheet are given in the Table.

### Examples 8 and 9

Examples 8 and 9 were meltblown nonwoven sheets made from polypropylene nanofibers. They were made according to the following procedure. A 1200 g/10 min melt water flow rate polypropylene was meltblown using a modular die as described in U.S. Pat. No. 6,114,017. The process conditions that were controlled to produce these samples were the attenuating air water flow rate, air temperature, polymer water flow rate and temperature, die body temperature, die to collector distance. Along with these parameters, the basis weights were varied by changing the changing the collection speed and polymer through put rate. The average fiber diameters of these samples were less than 500 nm. The sheets' physical and filtration properties are given in the Table.

### Comparative Example A

Comparative Example A was Tyvek® SoloFlo® (available from DuPont of Wilmington, Del.), a commercial flash spun nonwoven sheet product for liquid filtration applications such as waste water treatments. The product is rated as a 1 micrometer filter media which has 98% efficiency with 1 micrometer particles. The sheet's physical and filtration properties are given in the Table.

### Comparative Example B

Comparative Example B is a PolyPro XL disposal filter PPG-120 which is rated by retention at 1.2 micrometers (available from Cuno of Meriden, Conn.). It consists of polypropylene calendered meltblown filtration media rated for 1.2 micrometer. The sheet's physical and filtration properties are given in the Table.

### Comparative Examples C and D

Comparative Examples C and D were Oberlin 713-3000 a polypropylene spunbond/meltblown nonwoven sheet composite and Oberlin 722-1000 a polypropylene spunbond/meltblown/spunbond nonwoven sheet composite (available from Oberlin Filter Co. of Waukesha, Wis.). The sheets' physical and filtration properties are given in the Table.

### Comparative Example E

Comparative Example E is a precision woven synthetic monofilament fabric (i.e. mesh). The polyethylene terephthalate mesh characterized is PETEX 07-10/2 produced by Sefar (available from Sefar Inc., Depew, N.Y.). It is a highly specialized monofilament fabric characterized by precisely defined and controlled, consistent and repeatable material properties such as pore size, thickness, tensile strength, dimensional stability, cleanliness etc. The properties are given in the Table. In the Table, μm is used instead of micrometer for the sake of convenience.

| | | | | | | Filtration efficiency | | | | |
|---|---|---|---|---|---|---|---|---|---|---|
| | | | | | Water | % eff. | % eff. | % eff. | μm for | Life |
| | | BW | Thickness | MFP | Permeability | @1.0 | @2.0 | @3.0 | 90% | (min) to |
| Example | Media | (g/m2) | (μm) | (μm) | (ml/min/cm²/Kpa) | μm | μm | μm | eff. | Δ10 psi |
| 1 | FS HDPE-1 | 41.6 | 229 | 6.2 | 39.8 | 70.8 | 91.0 | 94.8 | 1.9 | 189 |
| 2 | FS HDPE-2 | 47.1 | 255 | 7.3 | 25.5 | 68.0 | 91.4 | 96.1 | 1.9 | 180 |
| 3 | FS-HDPE-3 | 51.4 | 208 | 5.0 | 7.3 | 84.7 | 97.4 | 98.9 | 1.3 | 196 |
| 4 | MB PP-1 | 98.3 | 346 | 1.4 | 2.1 | 96.3 | 99.6 | 99.6 | 0.65 | 210 |
| 5 | MB PP-2 | 98.8 | 425 | 1.9 | 4.4 | 83.7 | 97.9 | 98.5 | 1.2 | 242 |
| 6 | MB PP-3 | 147.2 | 752 | 2.4 | 11.2 | 76.7 | 97.9 | 98.9 | 1.35 | 259 |
| 7 | NFBM PES | 39.1 | 170 | 3.5 | 35.0 | 38.7 | 84.4 | 94.9 | 2.4 | 292 |
| 8 | NFBM PP-1 | 62.5 | 463 | 5.9 | 36.8 | 41.4 | 83.0 | 92.7 | 2.75 | 334 |
| 9 | NFBM PP-2 | 51.3 | 377 | 7.8 | 41.0 | 45.1 | 75.0 | 87.3 | 3.5 | 313 |
| A | FS-HDPE-4 | 40.3 | 140 | 2.8 | 1.8 | 97.9 | 99.8 | 99.8 | 0.4 | 72 |
| B | MB PP-4 | 105.4 | 330 | 0.8 | 0.7 | 99.6 | 99.7 | 99.7 | 0.33 | 182 |
| C | SM PP | 71.3 | 416 | 10.8 | 71.1 | 10.7 | 31.0 | 45.1 | 10 | 288 |
| D | SMS PP | 48.9 | 297 | 12.0 | 140.9 | 16.8 | 32.1 | 40.9 | >10 | 193 |
| E | PET mesh | 54.3 | 48 | 9.2 | 26.2 | 26.6 | 51.8 | 64.2 | 8.0 | 129 |

The nonwoven sheet of the Examples demonstrate an improvement in the overall combination of water flow rate and filtration efficiency in contrast to the other liquid filtration media including spunbond/meltblown sheets, spunbond/meltblown/spunbond sheets, nanofiber sheets and calendered meltblown sheets. This improvement would make it the most suitable for use in the process of the present invention.

We claim:

1. A method for recovering oil from a subterranean well, comprising the steps of;
i) recovering a water mixture from the well, where the water mixture comprises water, oil, and silica as either dissolved or particulate silica or any combination thereof;
ii) separating oil from the water mixture to produce a stream of water comprising dissolved and particulate silica;
iii) precipitating at least a portion of the dissolved silica;
iv) directing the produced water containing precipitated and particulate silica to a filtration medium;
v) passing essentially all of the produced water through the medium to produce a permeate stream and a filter cake;
wherein the medium has an efficiency of 30% or greater for particles of 1 micrometer size or greater and a flow rate of 2 milliliters per minute per centimeter square of media per kilopascal pressure of the liquid (ml/min/cm²/kPa), and filtering the produced water with the medium produces a filter cake upstream of, and in contact with, the medium and concentrated with the precipitated silica and wherein the filter cake is allowed to build to a pre-determined level.

2. The method of claim 1, wherein the stream of water produced in step (ii) is then split into two or more split streams, one or more of the split streams is further treated according steps (iii), (iv) and (v) and the permeate stream from step (v) that results from treatment of a split stream is then mixed with untreated split streams from step (ii).

3. The method of claim 1, wherein the medium comprises a nonwoven sheet.

4. The method of claim 3, in which the nonwoven sheet comprises polymeric fibers made from polymers selected from the group consisting of polyolefins, polyesters, polyamides, polyaramids, polysulfones and combinations thereof.

5. The method of claim 4, wherein the polymeric fibers are plexifilamentary fiber strands.

6. The method of claim 5, wherein the plexifilamentary fiber strands are made from polyolefin.

7. The method of claim 6, wherein the polyolefin is polyethylene.

8. The method of claim 5, wherein the nonwoven sheet is a uniaxially stretched nonwoven sheet in the machine direction.

9. The method of claim 1, wherein the filter media is replaced when the pressure drop across the media and filter cake reaches a pre-determined level.

10. The method of claim 1, wherein the filtration systems is an automatic pressure filter.

11. The method of claim 1, wherein the filter cake is dewatered and disposed off separately from the filtration media.

12. The method of claim 1, wherein the fluid stream is at 90° C.

13. The method of claim 1, wherein the fluid stream is above 100° C.

14. A system for removing oil from a subterranean well, comprising;
i) a means for separating oil from the water mixture to produce a stream of water having dissolved and particulate silica
ii) a means for precipitating the silica
iii) a filtration medium through which essentially all of the water passes
wherein the medium has an efficiency of 30% or greater for particles of 1 micrometer size or greater at a flow rate of 2 milliliters per minute per centimeter square of media per unit pressure of the liquid (ml/min/cm²/kPa), and filtering the produced water with the medium produces a filter cake upstream of, and in contact with, the medium and concentrated with the precipitated silica and wherein the filter cake is allowed to build to a pre-determined level until being replaced by a cake-free membrane.
